(19) United States
(12) Patent Application Publication
(10) Pub. No.: US 2010/0170074 A1
(43) Pub. Date: Jul. 8, 2010

(54) RAT TRAP

(75) Inventor: Preben Fritzboger, Helsinge (DK)

Correspondence Address: DARBY & DARBY P.C., P.O. BOX 770, Church Street Station, New York, NY, 10008-0770, US

(73) Assignee: PAF Holdings ApS, Helsinge (DK)

(21) Appl. No.: 12/528,459

(22) PCT Filed: Feb. 6, 2008
(86) PCT No.: PCT/EP08/51458

§ 371 Date: Nov. 9, 2009

Related U.S. Application Data
(63) Continuation of application No. 11/678,687, filed on Feb. 26, 2007.

(30) Foreign Application Priority Data
Oct. 19, 2007 (DK) PCT/DK2007/000449

(51) Int. Cl. B23P 17/04

(52) U.S. Cl. 29/428; 29/700

(57) ABSTRACT

A method and a console for the installation of powered equipment (1) in front of a sewer pipe opening (41) in a sewer shaft (50), the method comprising the steps of, selecting resilient tubular member (40) comprising a console adapted for mounting the powered equipment, the resilient tubular member having, in its unstressed state, an outer radius which slightly exceeds the inner radius of the sewer pipe opening, mounting. the powered equipment on the console positioning the resilient tubular member in front of the sewer pipe opening and compressing the resilient tubular member to obtain an outer radius being smaller than the inner radius of the sewer pipe opening, Inserting into the sewer pipe at least a part of the resilient tubular member, so that the console with the powered equipment extends inside the sewer shaft, releasing the compression of the resilient tubular member (40), so that it expands to engage with the inside of the sewer pipe opening (41).

The invention relates to installing powered equipment in front of a sewer pipe opening in a sewer shaft, the method comprising the steps of.

Such equipment can be used for many purposes such as monitoring and/or continuously recording the water level, flow rate, flow, water quality/pollution, PH value or temperature in the sewer pipes, or for exterminating rats. For instance, the trap may be equipped with one or more means for these tasks.

In this document a trap for exterminating rats is used as an example of such powered equipment.

From EP 1400172 is known a rat trap for exterminating rats in e.g. sewer pipes, and where powered equipment is arranged in the sewer pipe comprising means for sensing a rat, and means for killing the rat in the sewer pipe.

A problem with this kind of equipment is that the space required for the complete installation due to especially the power source such as a battery, a spring or compressed air requires that the equipment may only be installed in pipes having a relatively large cross section, or that at least a part the powered equipment must necessarily be installed outside the pipe and openings must be provided in the pipe in order for the powered equipment such as the means for killing rats to enter the pipe from the outside of the pipe.

According to the invention this is obtained by a method of installing powered equipment comprising the steps of;

Selecting a resilient cylindrical member comprising a console adapted for mounting the powered equipment to the resilient cylindrical member, and the resilient cylindrical member having, in its unstressed state, an outer radius which slightly exceeds the inner radius of the sewer pipe opening;

Mounting the powered equipment on the console of the resilient cylindrical member;

Positioning the resilient cylindrical member in front of the sewer pipe opening and compressing the resilient cylindrical member to have an outer radius being smaller than the inner radius of the sewer pipe opening;

Inserting at least part of the resilient cylindrical member into the sewer pipe, so that the console with the powered equipment extends inside the sewer shaft;

Releasing the compression of the resilient cylindrical member so that the resilient cylindrical member expands in order to engage with the inside of the sewer pipe opening.

By means of the resilient cylindrical member and its console for mounting the powered equipment it is hereby obtained that the sewer pipe is prolonged into the sewer shaft so that the sewer shaft provides space for the powered equipment, but still ensuring that rats move around as of they were still in the sewer pipe.

The invention also provides a console for installing powered equipment in front of a sewer pipe opening in a sewer shaft

### LIST OF FIGURES

Now the invention will be described in further detail with point of departure in the figures; wherein

FIG. 1 schematically shows the construction of an embodiment of the console with a powered equipment in the form of a rat trap mounted thereon;

FIG. 2 shows the rat trap according to FIG. 1, mounted in a sewer shaft;

FIG. 3 shows a console according to the invention for mounting in a sewer pipe including a mounting tool.

FIG. 4 shows a second embodiment of console according to the invention for mounting in a sewer pipe including a mounting tool.

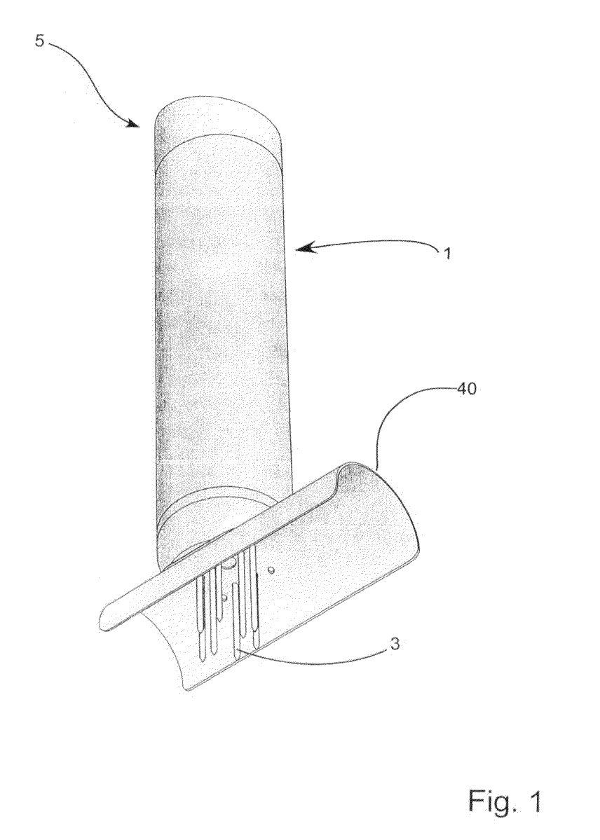

Reference being initially made to FIG. 1, an embodiment of the invention will be explained in further detail. The rat trap 1 comprises a power source such as a battery, and an automatic mechanism (not shown) which is capable of both firing the spikes 3 and pulling them back in order to thereby release a spiked rat. This rat trap is only to be seen as an example of a powered equipment to be mounted in a sewer shaft in front of a sewer pipe opening. Installing powered equipment in sewer pipes has until now been difficult because of the space required for installing the powered equipment in the sewer pipe.

On the other hand the sewer shaft provides a lot of space for installing equipment, but installation of e.g. a rat trap in the sewer shaft has the disadvantage that the rats may be able to pass the rat trap without activating it.

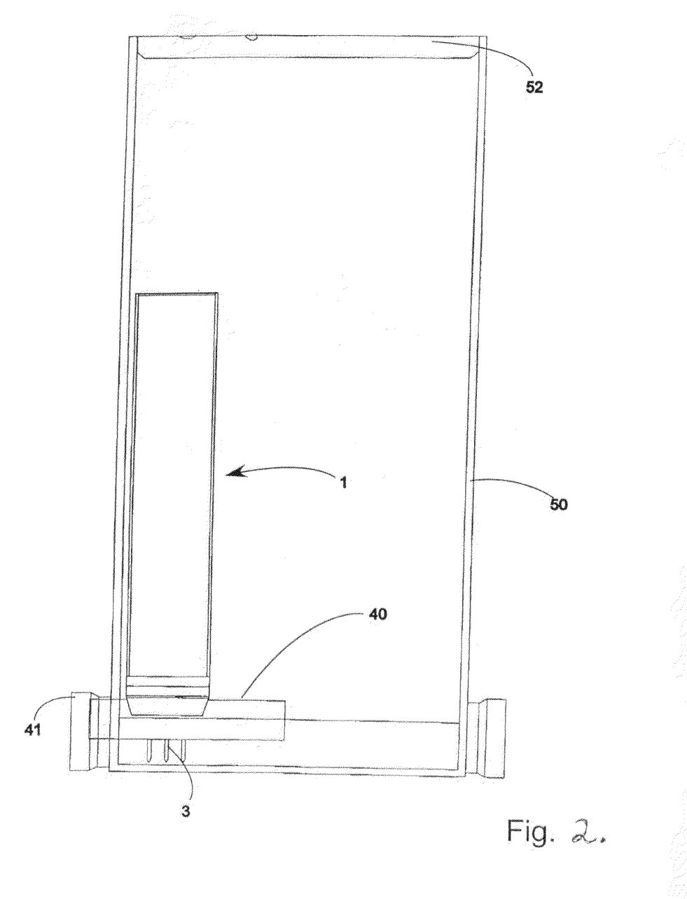

According to the invention FIG. 2 shows a trap 1 which is arranged at the bottom of a sewer shaft 50. The trap 1 is mounted on a console 40 which in the shown embodiment is a flexible semi-cylindrical tubular member 40 that resiliently engages a sewer pipe 41 but the mounting member could also be in form of e.g, semi-cylindrical tubular member being provided with expanding means such that it is capable of engaging the inner side of a pipe. The resilient member 40 may be made out of steel but other materials may be used such as e.g. plastic.

In its unstressed state, the resilient tubular member 40 has an outer radius which slightly exceeds the inner radius of the sewer pipe 41. Thereby the trap is easily fastened therein merely by a trap mounting tool compressing the tubular member 40 to such suitable extent that the tubular member 40 can be inserted into the sewer pipe 41. Then the mounting tool inserts the tubular member 40 into the sewer pipe 41 and lets go of it, following which the tubular member 40 resiliently engages the inside of the sewer pipe 41. Even though the member 40 is described as being made out of resilient material other solutions known to the skilled person may be used, such as e.g. mechanically expanding sleeves. For illustrative purposes, the trap is shown with the spikes out, but of course this is usually not the case unless the trap is to be serviced or the like.

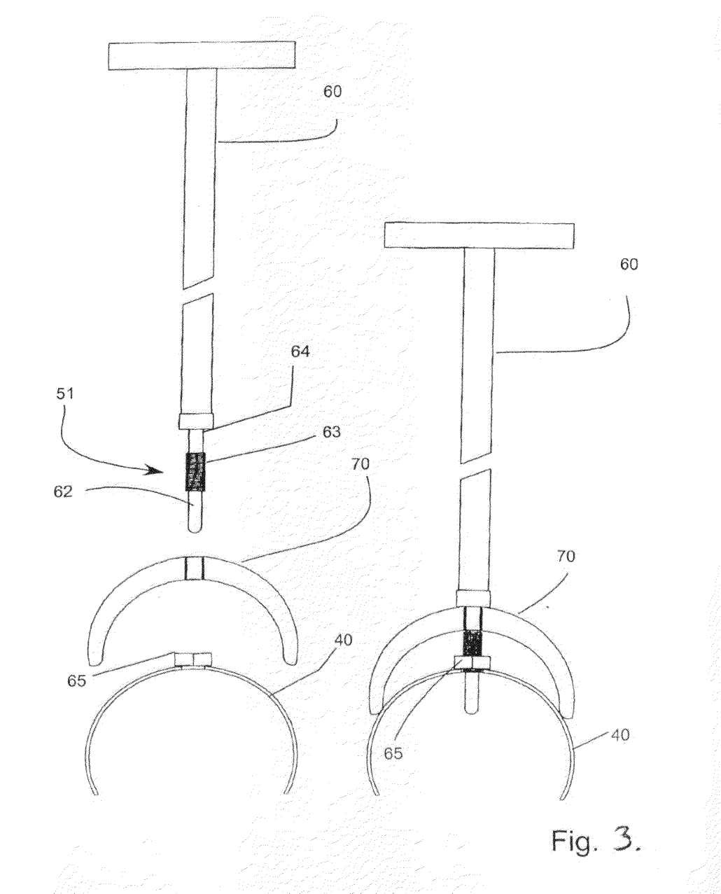

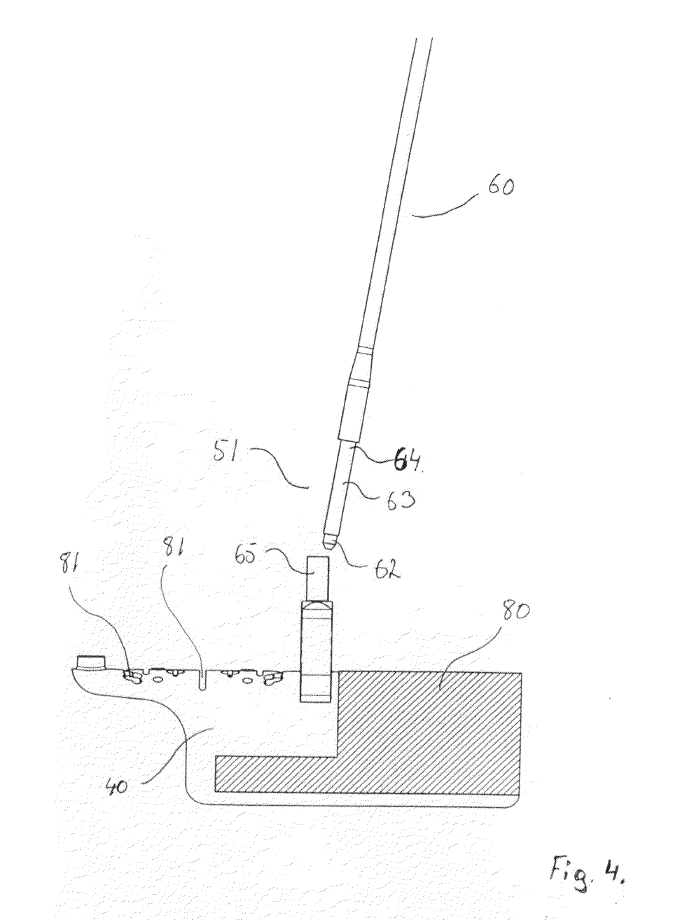

FIGS. 3 and 4 shows a console according to the invention comprising a tool for mounting a trap in a sewer shaft and the functionality of it will be explained in further detail in the following. The tool consists of two parts: a handle part 60 and a jaw 70 having two fingers extending on each side of the console 40. Moreover, the figure also shows a resilient tubular member 40. As explained above, the trap or other powered equipment will usually be mounted on the console 40, but for the sake of clarity this is not the case in the depiction shown in FIG. 3.

The handle part is provided with a mounting pin 61, being in the shown embodiment divided into three pieces 62, 63, 64, where only the middlemost part 63 is provided with thread. The mounting pin is adapted to the jaw 70 in such a manner that the thread mates with corresponding thread in the stop plate, and the thread-less part of the mounting pin 64 which is situated after the thread 63 is adapted to the thickness of the stop plate to the effect that the mounting pin 62, 63, 64 can be turned so far into the stop plate 70 that the thread 63 on the mounting pin 61 does not engage with the thread of the stop plate. Like the stop plate, the resilient tubular member 40 is provided with a thread mating with the thread on the mounting pin 60. That thread can be constituted (as shown in the Figure) of a nut 65, but of course the thread can be made in a variety of other ways.

When the tool is to be used, one starts out by mounting the jaw 70 on the mounting shaft 51. Then one may turn the thread 63 of the mounting pin into the nut on the tubular element 40 and thereby the tubular member 40 is pulled into the convex portion of the jaw 70. During this process the tubular member 40 is deformed (compressed). The mounting tool continues this deformation until the tubular member 40 can be pressed into the sewer pipe where the trap is to be mounted (not shown), following which the mounting tool deploys the trap simply by turning the mounting pin out of engagement with the tubular member 40.

Even though the jaw 70 can be secured to the mounting pin in many ways, eg by means of a known split pin system (arranged on the top face of the thread portion 63 or a corresponding place) the embodiment as shown in FIG. 5 is associated with the advantage that several sizes of jaws (different diameters/curvatures) can be mounted on the same mounting pin 61. Thereby the mounting tool needs only one handle part which can then be used for several different (different diameters/curvatures) jaws which he selects in response to the size of tubular element 49 (fitted with trap) to be mounted in a sewer.

In FIG. 4 the console is shown from its outside on one side, and as can be seen the tubular part of the console is provided with a friction increasing material 80. The friction increasing material is preferably made from rubber in order to provide good friction between the tubular part of the console and the inside of the sewer pipe, but any friction increasing material can be selected for specific purposes. Furthermore a number of holes 81 are extending through the console from its outside to its inside is arranged for mount of the powered equipment such as the rat trap according to FIGS. 1 and 2, and for allowing e.g. the spikes 3 to enter into the inside of the console from its outside.

The trap may advantageously also be equipped with means for other monitoring tasks. For instance, the trap may be equipped with one or more means for tasks such as monitoring and continuously recording the water level, flow rate, flow, water quality/pollution, PH value or temperature.

1. A method of mounting powered equipment in front of a sewer pipe opening in a sewer shaft, the method comprising the steps of
Selecting a resilient tubular member comprising a console adapted for mounting the powered equipment to the resilient tubular member, and the resilient tubular member having, in its unstressed state, an outer radius which slightly exceeds the inner radius of the sewer pipe opening;
Mounting the powered equipment on the console of the resilient tubular member;
Positioning the resilient tubular member in front of the sewer pipe opening and compressing the resilient tubular member to have an outer radius being smaller than the inner radius of the sewer pipe opening;
Inserting at least part of the resilient tubular member into the sewer pipe, so that the console with the powered equipment extends inside the sewer shaft;
Releasing the compression of the resilient tubular member, so that the resilient cylindrical member expands to engage with the inside of the sewer pipe opening.

2. A method according to claim 1, characterised in, that the positioning of the resilient tubular member in front of the sewer pipe comprises the use of a mounting tool extending from above the sewer shaft for lowering of the resilient tubular member into the sewer shaft, with the powered equipment mounted thereon.

3. A console for mounting powered equipment in front of a sewer pipe opening in a sewer shaft, characterised in, that it has a first end comprising a tubular part made from a resilient material, and where the tubular part has a longitudinal slit allowing the tubular part to be compressed to a smaller cross section, and a second end having means for mounting powered equipment.

4. A console according to claim 3, characterised in, that the means for mounting powered equipment comprises a mounting plate having a number of holes extending from the outside of the console to the inside.

5. A console according to claim 3, characterised in, that at least the tubular part is made of resilient plastic.

6. A console according to claim 5, characterised in, that at least part of the outside of the tubular part is covered with a friction increasing material such as rubber for increasing friction between the tubular part and the sewer pipe.

7. A console according any of claims 3 to 6, characterised in, that it comprises a tool for compressing the tubular part.

8. A console according to claim 7, characterised in, that the tool comprises a jaw having at least two fingers spaced apart from each other with a distance being smaller than the outer radius of the tubular part, and means for pressing the fingers against the outside of the tubular part.

9. A console according to claim 8, characterised in, that the means for pressing the fingers against the outside of the tubular part comprises a shaft having an outer thread and a flange at the end of the outer thread, and a hole in the tubular part having an inner thread for receiving the outer thread of the shaft, and where the jaw has a hole between the fingers for receiving the threaded end of the shaft and for engaging with the flange on the shaft, so that when the shaft is rotated it is screwed into the tubular part, and the flange on the shaft presses the fingers on the jaw to compress the tubular part.

10. A console according to claim 7, 8 or 9, characterised in, that the shaft is telescopic or made from two or more shaft sections that can be assembled to each other.
